(19) United States
(12) Patent Application Publication
(10) Pub. No.: US 2014/0237826 A1
(43) Pub. Date: Aug. 28, 2014

(54) Rotary Cutter with Cutting Wheel Having Side Faces Configured to Prevent Food Items from Sticking to Cutting Wheel

(71) Applicant: FOCUS PRODUCTS GROUP INTERNATIONAL, LLC, (US)

(72) Inventor: Christopher M. Dorion, Elmhurst, IL (US)

(73) Assignee: FOCUS PRODUCTS GROUP INTERNATIONAL, LLC, Lincolnshire, IL (US)

(21) Appl. No.: 13/777,021

(22) Filed: Feb. 26, 2013

(51) Int. Cl. B26B 25/00

(52) U.S. Cl. CPC B26B 25/005
USPC 30/319

(57) ABSTRACT

A rotary cutter comprises a handle with an axle portion and a gripping portion spaced from the axle portion. The cutter also includes a mesh wheel having a center axis of rotation that is operatively connected with the axle portion of the handle at the center axis of rotation thereby enabling the mesh wheel to rotate about its center axis relative to the handle. The mesh wheel has cutting surfaces on its outer peripheral edge. The rotary cutter side faces are configured to prevent food items from sticking to the cutting wheel. The rotary cutter is especially useful for cutting marshmallow and other sticky food items.

### BACKGROUND AND SUMMARY

The following disclosure relates to a rotary cutter. More specifically, the following disclosure relates to a rotary cutter having side faces configured to prevent food items from sticking to the cutting wheel. The rotary cutter is especially useful for cutting marshmallow and other sticky food items.

### BRIEF DESCRIPTION OF THE DRAWINGS

FIG. 1 is a perspective view of a rotary cutter;

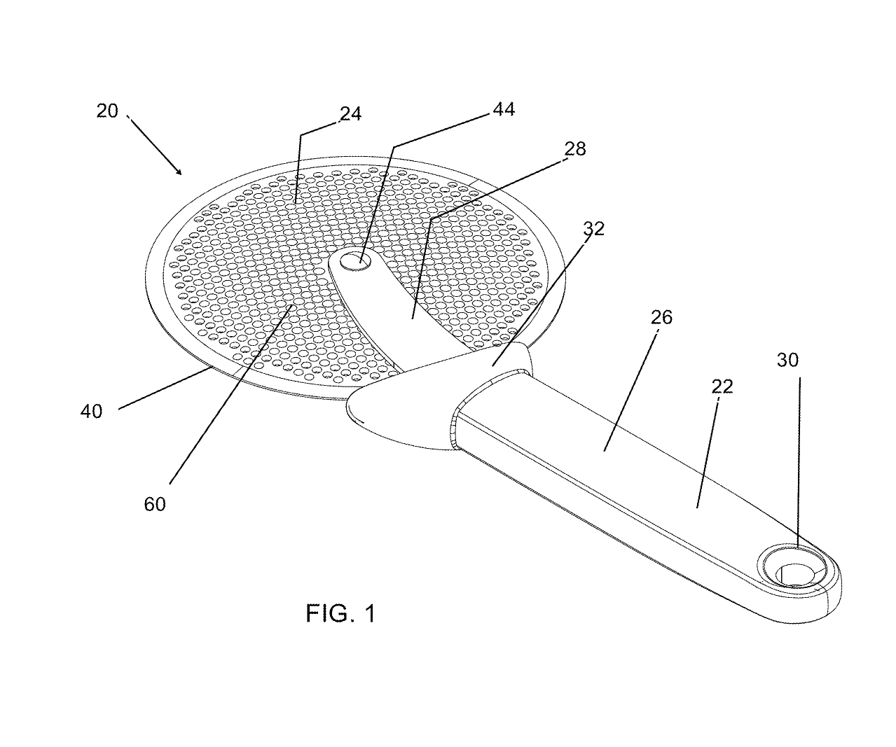

FIG. 2 is an alternate perspective view of the rotary cutter of FIG. 1;

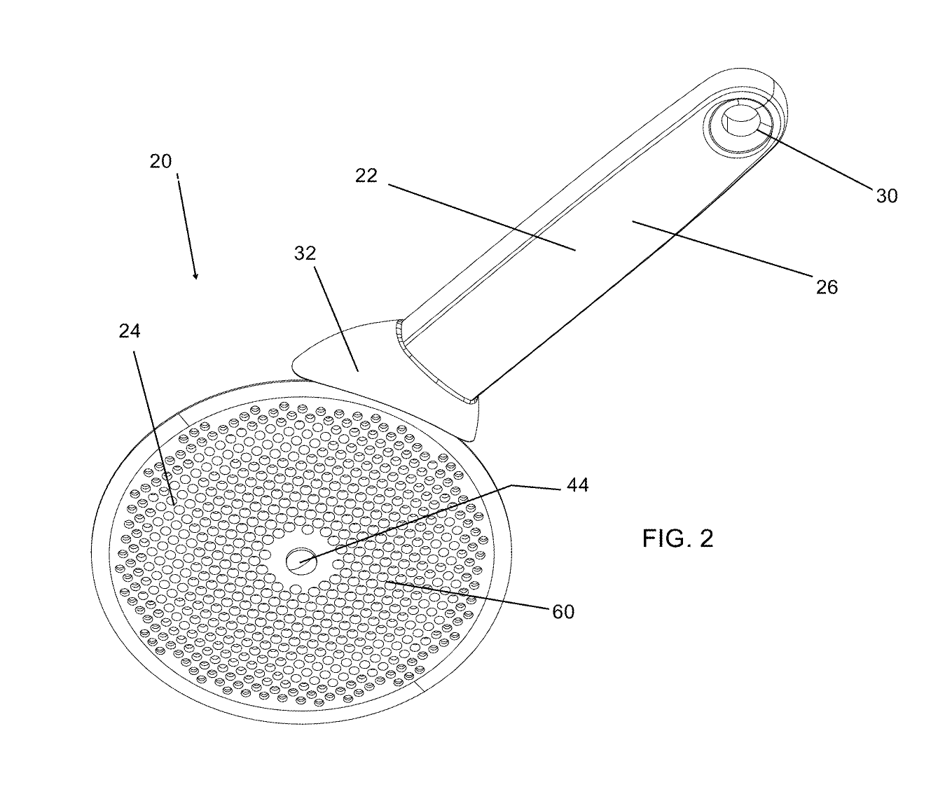

FIG. 3 is a front view of the rotary cutter of FIG. 1;

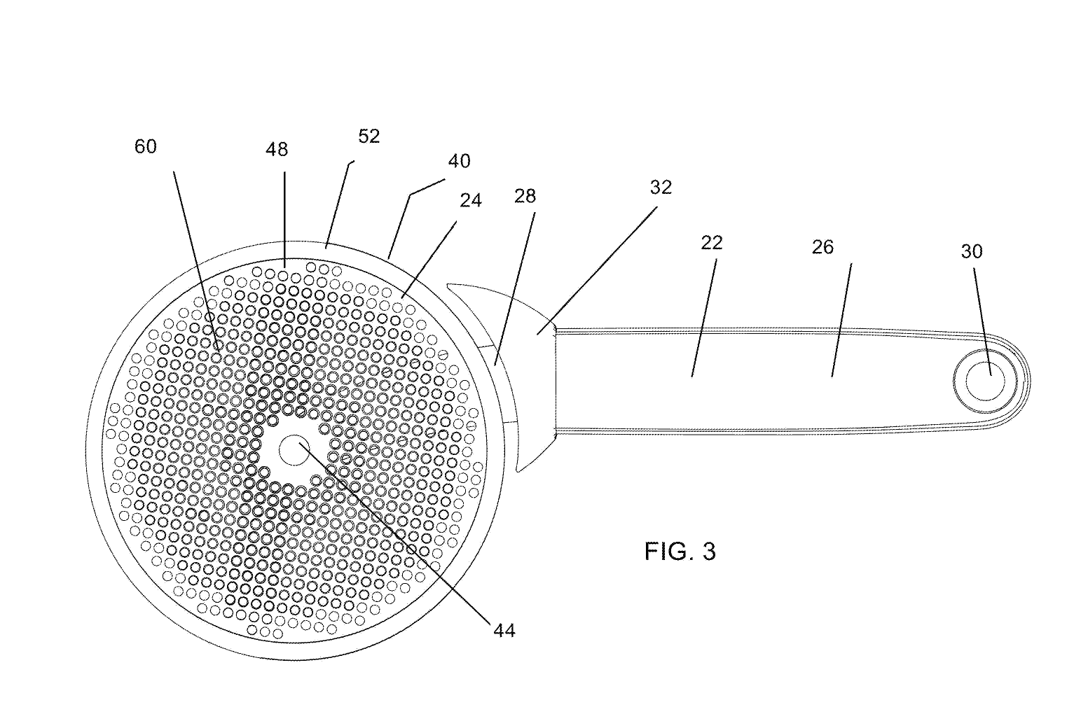

FIG. 4 is a back view of the rotary cutter of FIG. 1;

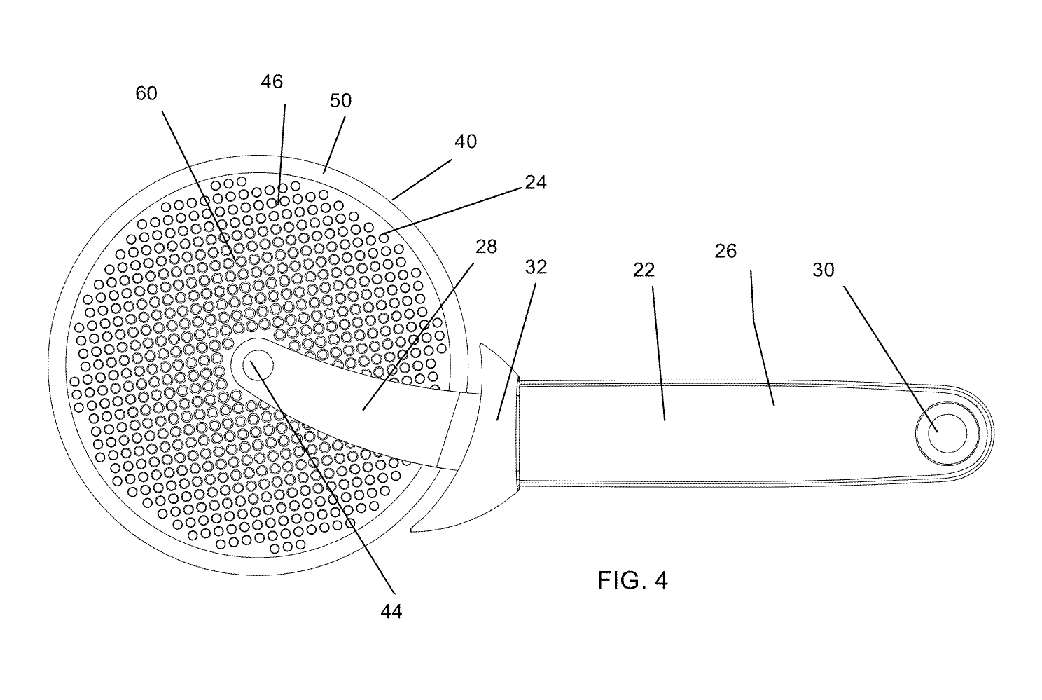

FIG. 5 is a left side view of the rotary cutter of FIG. 1;

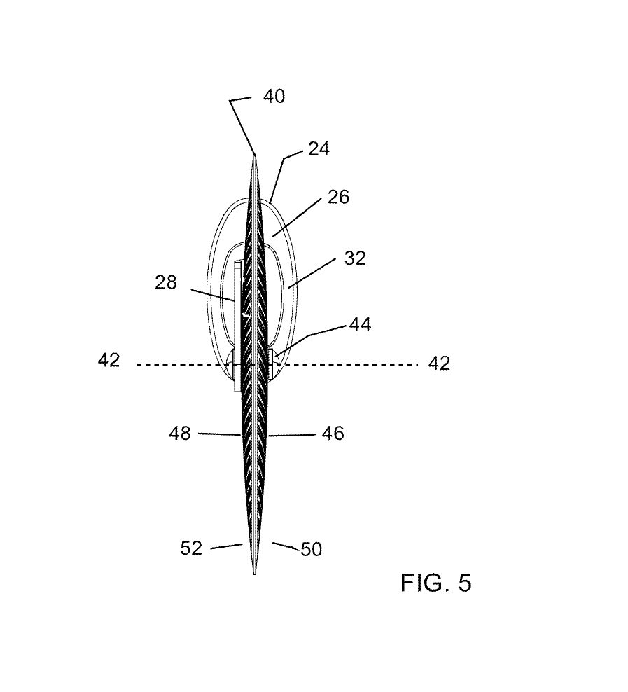

FIG. 6 is a right side view of the rotary cutter FIG. 1;

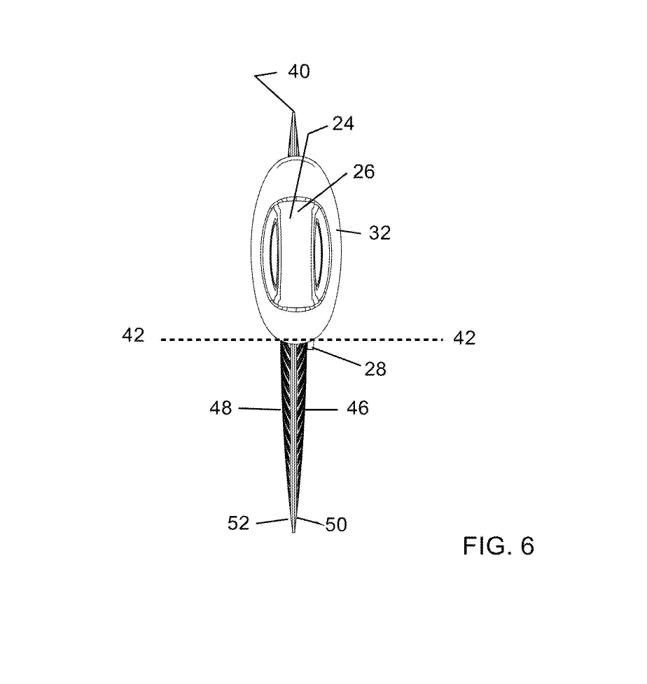

FIG. 7 is a top view of the rotary cutter of FIG. 1; and

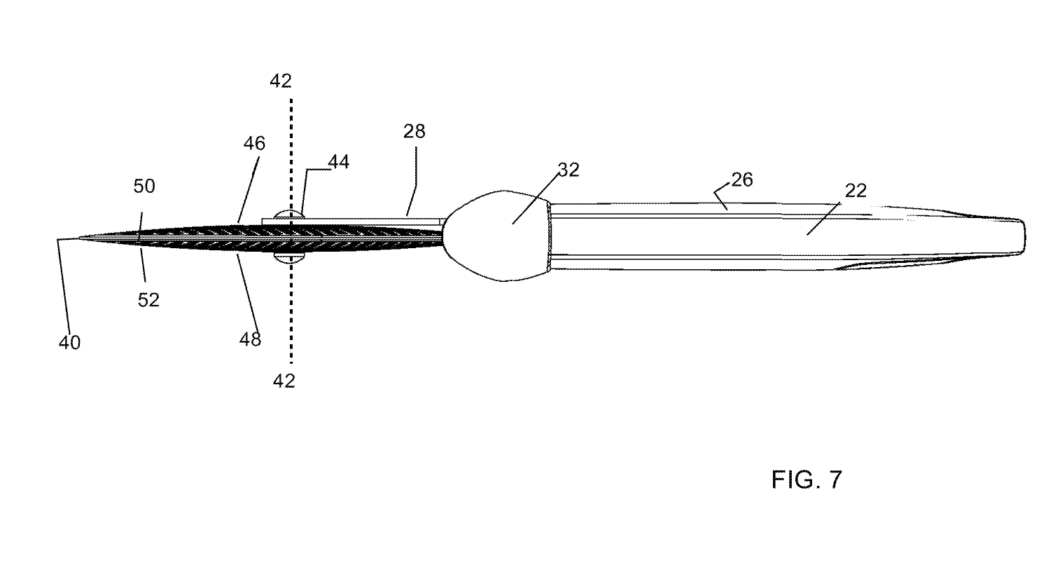

FIG. 8 is a bottom view of the rotary cutter of FIG. 1.

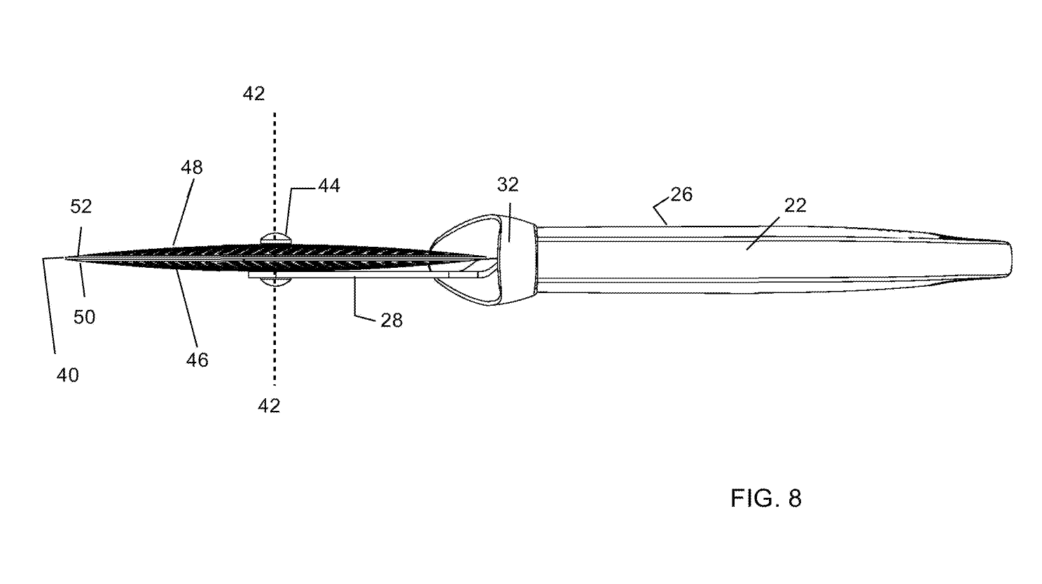

### DETAILED DESCRIPTION

The rotary cutter 20 comprises a handle 22 operatively connected to a cutting wheel 24 to allow rotation of the cutting wheel relative to the handle. As shown in the drawings, the handle 22 may be elongate member with opposite ends with a gripping portion 26 on one end and an axle portion 28 formed on an opposite end. The handle gripping portion 26 may have an eyelet 30 to enable the rotary cutter to be hung on a hook or the like. The gripping portion 26 may also have a guard or hilt 32. The guard 32 may be placed on the handle 22 in a transition area between the gripping portion 26 and the axle portion 28. Although the handle is shown in the drawings as an elongate member, other arrangements may also be used. It is not necessary that the handle extend away from the cutting wheel. The handle may be disposed over the cutting wheel. For instance, the handle may comprise a body with a hollow interior that receives a portion of the cutting wheel.

Preferably, the cutting wheel 24 is circular with a circular cutting edge on its outer peripheral edge 40. The outer peripheral edge 40 may define a plane of the cutting wheel. The cutting wheel 24 may have a center axis 42 that defines an axis of rotation for the cutting wheel. The axis of rotation 42 may be perpendicular to the plane of the cutting wheel. The cutting wheel 24 may be operatively connected with the axle portion 28 of the handle at the cutting wheel center axis 42 to enable the cutting wheel to rotate about it center axis. For instance, a pin 44 may extend through the wheel center axis 42 to connect the cutting wheel 24 to the handle axle portion 28. Preferably, the rotary cutter rotates about its center axis as the outer peripheral edge rolls across a cutting surface when cutting a food item. The cutting wheel has side faces 46,48 that are perpendicular to the cutting wheel center axis 42. Bevels 50,52 may extend between the sides faces and cutting edge or the outer peripheral edge 40. Although the outer peripheral edge 40 is shown as a circular edge, the outer peripheral edge may also be serrated, scalloped, beveled, or formed with teeth, and thus, have multiple cutting surfaces.

As will become evident from the discussion that follows, the cutting wheel side faces 46,48 are configured with surface features 60 to reduce the tendency of sticky foods from sticking to the cutting wheel. The surface features 60 on the side faces are also configured to enable flour, confectioner's sugar or corn starch to stick to the wheel in the surface feature, thereby further reducing the tendency of sticky foods from sticking to the cutting wheel. Preferably, the surface features 50 of the wheel are configured to allow the rotary cutter to be easily cleaned. To that end, the surface features 60 may have tapers or tapered transition to the side faces 46, 48. Additionally, the sizes of the surface features 60 are preferably dimensioned to enable the rotary cutter to be cleaned while maintaining structural integrity for the cutting wheel. Preferably, the number of surface features is between 9 and 100 per square inch over a substantial area of the wheel. More preferably, the number of surface features is between 36 and 64 per square inch over a substantial area of the wheel. The size of the surface features may be between 0.062 inches and 0.281 inches in diameter or major dimension. More preferably, the size of the surface features may be between 0.080 inches and 0.120 inches diameter or major dimension. The wheel may be a disk-like member. The cutting wheel surface features may include perforations through the wheel and/or a plurality of recesses formed in the cutting wheel. At least some of the recesses may extend through the side faces of the cutting wheel to form the plurality of perforations. The wheel may comprise a mesh with a plurality of openings. The wheel may be made from a nylon material. The wheel may also be made of Tritan™, a copolyester material available from Eastman Chemical Company of Kingsport, Tenn. Alternate materials may include thermoplastics, cast aluminum, wire or steel. The wheel may have a nonstick coating, such as silicone. While the drawings show the perforations as round, the perforations may be other shapes, for instance, square, hexagonal, or irregularly shaped or abstractly shaped.

While specific embodiments have been described in detail and in the foregoing detailed description and illustrated in the accompanied drawings, those with ordinary skill in the art will appreciate that various modifications and alternatives to those details could be developed in light of the overall teachings of the disclosure. Accordingly, the specific embodiments disclosed and particular ranges disclosed were meant to be illustrative only and not limited as to the scope of the invention, which is to be given the full breath of the appended claims and any and all equivalents thereof.

What is claimed is:

1. A rotary cutter comprising:
a handle with an axle portion and a gripping portion spaced from the axle portion; and
a cutting wheel having a circular cutting edge defined by an outer periphery of the cutting wheel, the outer periphery defining a plane of the cutting wheel, the cutting wheel having a center axis of rotation perpendicular to the plane of the cutting wheel, the cutting wheel being operatively connected with the axle portion of the handle at the cutting wheel center axis of rotation thereby enabling the cutting wheel to rotate about its center axis relative to the handle, the cutting wheel having a plurality of perforations radially inward of the outer periphery forming a sieve portion on the cutting wheel.

2. The cutter of claim 1, wherein the cutting wheel has between 9 and 100 perforations per square inch over a substantial area of the cutting wheel.

3. The cutter of claim 2, wherein the cutting wheel has between 36 and 64 perforations per square inch over a substantial area of the cutting wheel.

4. The cutter of claim 1, wherein the cutting wheel perforations are tapered.

5. The cutter of claim 1, wherein the cutting wheel perforations have a diameter at a point through the cutting wheel of between 0.062 inches and 0.281 inches.

6. The cutter of claim 5, wherein the cutting wheel perforations have a diameter at a point through the cutting wheel of between 0.080 inches and 0.120 inches.

7. The cutter of claim 1, wherein the cutting wheel is formed from a copolyester material.

8. A rotary cutter comprising:
a handle with an axle portion and a gripping portion spaced from the axle portion; and
a mesh wheel having a center axis of rotation operatively connected with the axle portion of the handle thereby enabling the mesh wheel to rotate about its center axis relative to the handle, the mesh wheel having cutting surfaces on its outer peripheral edge.

9. The cutter of claim 8, wherein the mesh wheel has between 9 and 100 openings per square inch over a substantial area of the mesh wheel.

10. The cutter of claim 9, wherein the mesh wheel has between 36 and 64 openings per square inch over a substantial area of the mesh wheel.

11. The cutter of claim 8, wherein the mesh wheel comprises a plurality of perforations in a disk-like member.

12. The cutter of claim 11, wherein the mesh wheel perforations are tapered.

13. The cutter of claim 11, wherein the cutting wheel perforations have a diameter at a point through the cutting wheel of between 0.062 inches and 0.281 inches.

14. The cutter of claim 13, wherein the cutting wheel perforations have a diameter at a point through the cutting wheel of between 0.080 inches and 0.120 inches.

15. The cutter of claim 11, wherein the disk-like member is formed from a copolyester material.

16. A rotary cutter comprising:
a handle with an axle portion and a gripping portion spaced from the axle portion; and
a cutting wheel having a center axis of rotation operatively connected with the axle portion of the handle thereby enabling the cutting wheel to rotate about its center axis relative to the handle, the cutting wheel having cutting surfaces on its outer peripheral edge, the cutting wheel have side faces perpendicular to the center axis of rotation, each of the side faces having a plurality of recesses, the plurality of recesses numbering between 9 and 100 per square inch over a substantial area of the cutting wheel.

17. The cutter of claim 16, wherein each of the cutting wheel side faces has between 36 and 64 recesses per square inch over a substantial area of the cutting wheel.

18. The cutter of claim 16, wherein the recesses extend through the sides faces of the cutting wheel to form perforations in the wheel.

19. The cutter of claim 18, wherein the cutting wheel perforations have a diameter at a point through the cutting wheel of between 0.062 inches and 0.281 inches.

20. The cutter of claim 18, wherein the cutting wheel perforations have a diameter at a point through the cutting wheel of between 0.080 inches and 0.120 inches.
